(19) United States
(12) Patent Application Publication
(10) Pub. No.: US 2006/0071038 A1
(43) Pub. Date: Apr. 6, 2006

(54) Spillage-free fluid container

(76) Inventor: David Yang, Moraga, CA (US)

Correspondence Address: DAVID YANG, 1020 WICKHAM DR., MORAGA, CA, 94556, US

(21) Appl. No.: 10/957,901

(22) Filed: Oct. 5, 2004

(51) Int. Cl. G01F 11/26

(52) U.S. Cl. 222/454

(57) ABSTRACT

A fluid bottle is provided with an interior partition wall and an interior opening that divide the fluid bottle into an interior passage section and a reservoir section. The interior passage transports fluid content between reservoir and discharge spout of bottle. The partition wall keeps fluid content in reservoir as bottle being rotated from storage position to alignment position. At alignment position, the discharge spout of bottle is at about the lowest level of the bottle, which enables discharge spout accessing and aligning to the fill port of a receiver. Consequently, the fluid bottle prevents a premature fluid discharge or spillage while discharge spout accessing and aligning to the fill port.

### BACKGROUND OF THE INVENTION

The present invention relates to a plastic fluid container, particularly a plastic motor oil bottle, which prevents spillage during pouring oil into the fill port of an automobile engine crankcase.

Oil spillage has been a common problem during pouring oil from a motor oil bottle into the fill port of an automobile engine crankcase. The conventional motor oil bottle begins discharging oil as the bottle being tilted by a small degree. However, the bottle normally requires to be tilted by a larger degree in order to allow the discharge spout of the bottle to be closely aligned to the fill port. This means the bottle begins discharging oil prematurely while the discharge spout is still in a distance and height from the fill port. Consequently, to avoid oil spillage over the engine body outside of the fill port, the jet stream of oil discharge must be precisely aimed at the opening of fill port. However, this is almost an impossible task due to the “glug” effect of the oil discharge.

U.S. Pat. No. 4,877,142 discloses a rectangular motor oil bottle (FIG. 1) in an attempt to improve the volume efficiency and pouring ability of the bottle. However, the bottle does not to eliminate oil spillage problem. The bottle comprises of a hollow body, and a discharge spout integrated to the top of the hollow body. The hollow body comprises of a front wall, a back wall, a bottom wall, a left side wall, a right side wall, and a top wall slopping down from the right side wall toward the left side wall. The discharge spout is offset from the left side wall toward the right side wall. As the bottle being tilted in the direction from the right side wall to the left side wall, the bottle can be tilted by a maximum angle of approximately 75 degree before commencing oil discharge. However, the bottle requires to be tilted by a significantly larger angle for the discharge spout accessing the fill port of an engine crankcase. Consequently, the bottle is not able to prevent a premature oil discharge or spillage.

Many closure devices in prior art can be used in a motor oil bottle for preventing a premature oil discharge or spillage. For example, see U.S. Pat. Nos. 5,110,017, 5,411,186, 5,897,037, 4,832,221, 4,979,653, 5,405,034, 6,053,366, 6,439,441, 5,246,150, 5,265,777, 4,619,290, 6,264,121, 5,005,732, 5,989,469, 6,116,465, and 6,412,665. These closure devices can be kept closed until the discharge spout of the bottle being properly aligned to the fill port of the engine crankcase. The disadvantages of using a closure device are not only a cost factor, but also the reliability of the closure device. In some cases, a closure device may significantly reduce flow rate. In all cases, the closure device increases the time and effort for the oil filling process.

Many rupture seals in prior art have been proposed for solving spillage problem. For example, see U.S. Pat. Nos. 4,898,293, 5,020,690, and 5,316,058. The rupture seal is breakable upon impacting force or squeezing action. The disadvantages of using a rupture seal are not only a cost factor or reliability, but also a potential risk of an accidental actuation.

### SUMMARY OF THE INVENTION

The object of the invention is to provide a fluid bottle that prevents a premature fluid discharge or spillage while aligning the discharge spout of the bottle to the fill port of a receiver.

Another object of the invention is to provide a fluid bottle that can be rotated to position the discharge spout of the bottle from about the highest level to the lowest level of the bottle without discharging fluid content out of bottle.

Another object of the invention is to provide a fluid bottle that can be rotated to position the discharge spout from about the highest level to the lowest level of the bottle while accessing and aligning to the fill port of a receiver.

Another object of the invention is to provide a fluid bottle that prevents a premature discharge and spillage without using a closure device, a moving part or a rupture seal.

Another object of the invention is to provide a fluid bottle that prevents a premature discharge or spillage without adversely affecting the volume efficiency and overall size of the bottle.

Another object of the invention is to provide a fluid bottle that prevents a premature discharge and spillage without adversely affecting the pouring ability and pouring rate of the bottle.

Another object of the invention is to provide a fluid bottle that prevents a premature discharge and spillage without increasing the effort and difficulty during a pouring process.

Another object of the invention is to provide the above spill-free fluid bottle that is entirely made from a plastic molding process.

### BRIEF DESCRIPTION OF THE DRAWINGS FIG. 1 is a perspective view of a conventional (quarter-size) motor oil bottle of prior art.

FIG. 2 is a perspective view of the first preferred embodiment of the fluid bottle of present invention at a storage position.

FIG. 3 is a cross section view A-A of the fluid bottle of FIG. 2 at a storage position.

FIG. 4 is a cross section view A-A of the fluid bottle of FIG. 2 at a tilted position.

FIG. 5 is a diagrammatic view of the fluid bottle of FIG. 2 at an alignment position.

FIG. 6 is a diagrammatic view of the fluid bottle of FIG. 2 at a final pouring position.

FIG. 7 is a perspective view of the second preferred embodiment of the fluid bottle of present invention at a storage position.

FIG. 8 is a cross section view A-A of the fluid bottle of FIG. 7 at a storage position.

FIG. 9 is a perspective view of the third preferred embodiment of the fluid bottle of present invention at a storage position.

FIG. 10 is a cross section view A-A of the fluid bottle of FIG. 9 at a storage position.

### DETAILED DESCRIPTION OF THE PREFERRED EMBODIMENT

FIG. 1 is a perspective view of a commonly used quarter-size motor oil bottle of prior art. As previously discussed in Background of the Invention, the bottle suffers a premature oil discharge or spillage while aligning the discharge spout of the bottle to the fill port of engine crankcase.

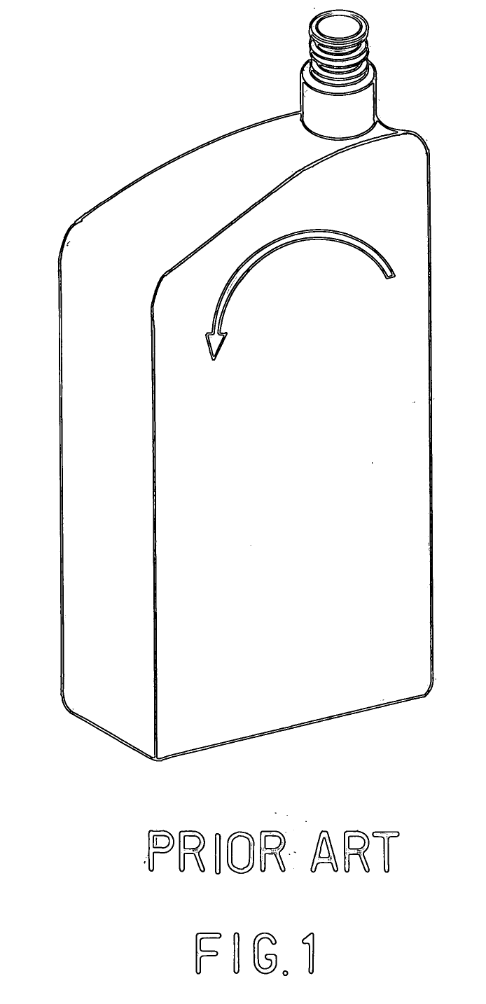

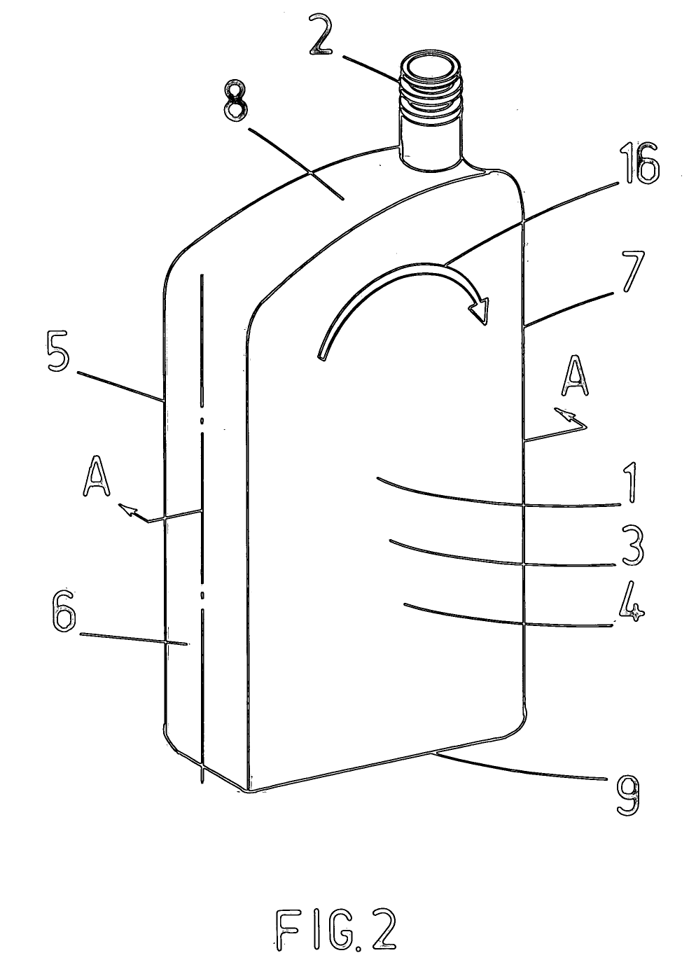

FIG. 2 is a perspective view of the first preferred embodiment of the fluid bottle of the present invention. The exterior appearance of the bottle in FIG. 2 closely resembles to the exterior appearance of the bottle in FIG. 1. This similarity allows the fluid bottle of present invention to be filled and packaged by the existing bottle plant and facilities of the bottle of prior art. FIG. 3 is a cross sectional view A-A of FIG. 2. In FIG. 2 and FIG. 3, the fluid bottle 1 comprises of a discharge spout 2, and a hollow body 3 that has a front wall 4, a back wall 5, a left side wall 6, a right side wall 7, a top wall 8, a bottom wall 9, and an interior partition wall 10. The discharge spout 2 is a hollow, open tube integrated to top wall 8 through which bottle 1 can be filled and emptied. The interior partition wall 10 divides hollow body 3 into an interior passage section 11 and a reservoir section 12. The interior partition wall 10 is integrally connected and sealed to the right side wall 7, front wall 4 and back wall 5. Preferably, interior partition wall 10 is substantially in parallel to the bottom wall 9. The hollow body 3 is generally a rectangular shape, in which the front wall 4 and back wall 5 are substantially parallel, and the left side wall 6 and right side wall 7 are substantially parallel. The centerline of discharge spout 2 is offset from left side wall 6 toward right side wall 7. The first opening 13 of interior passage 11 is formed at the joint where the discharge spout 2 connects to the top wall 8. The second opening 14 of interior passage 11 is formed between the left side wall 6 and the free end of the interior partition wall 10. As a result, the first opening 13 is offset from left side wall 6 toward right side wall 7, and the second opening 14 is offset from right side wall 7 toward left side wall 6. The first opening 13 allows fluid content to be transported between the discharge spout 2 and interior passage 11. The second opening 14 allows fluid content to be transported between interior passage 11 and reservoir 12. A rotation arrow 16 in the direction from left side wall 6 to right side wall 7 is marked on front wall 4 and back wall 5. FIG. 3 shows bottle 1 being filled to a full storage capacity, in which the fluid level in reservoir 12 is at level 15 below second opening 14. The “h” in FIG. 3 represents the height of fluid content between level 15 and bottom wall 9 while bottle 1 being at storage position.

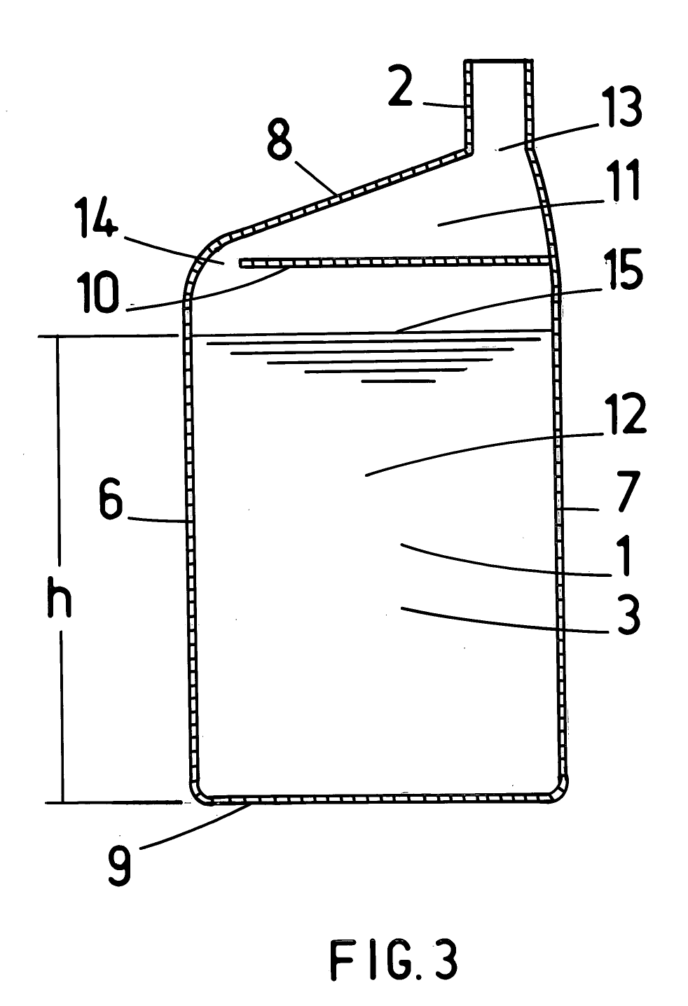

FIG. 4 shows bottle 1 being slightly tilted in the direction of arrow 16 from the left side wall 6 to the right side wall 7. Fluid content remains within reservoir 12 as long as the fluid level remains below the second opening 14.

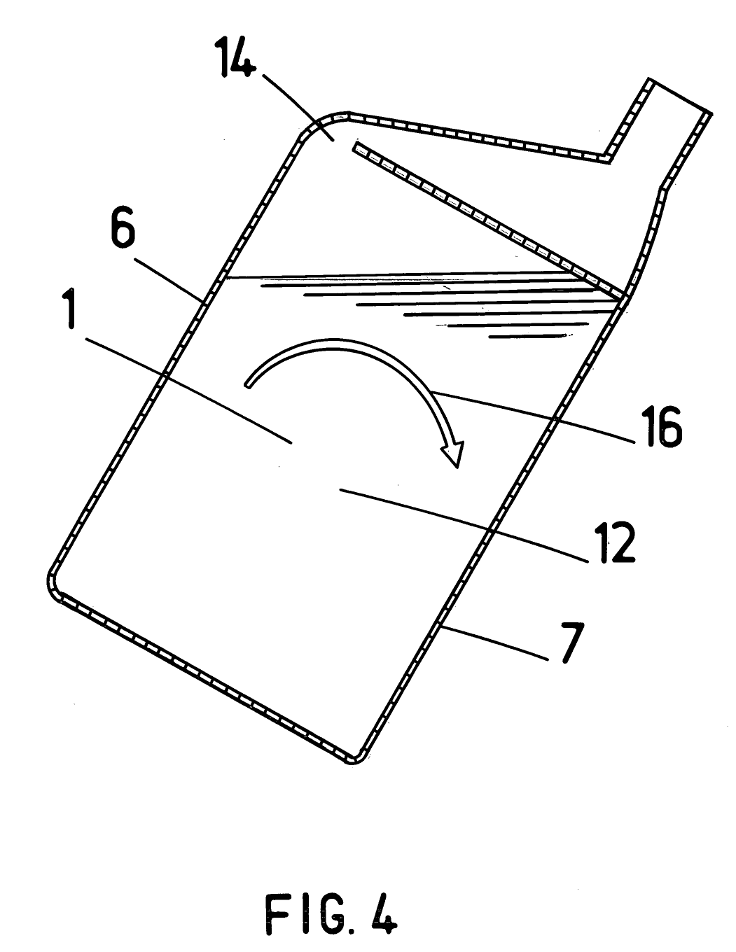

FIG. 5 shows bottle 1 at an alignment position. Bottle 1 is rotated 90 degree from the storage position (FIG. 2 & FIG. 3) to the alignment position in the direction of arrow 16 from the left side wall 6 to the right side wall 7. At the alignment position, discharge spout 2 and opening 13 are at about the lowest level of bottle 1, while opening 14 is at about the highest level of bottle 1. In FIG. 5, “W” represents the width of bottle 1 between left side wall 6 and right side wall 7. The “z” in FIG. 5 represents a distance that defines the height of reservoir 12 between the interior partition wall 10 and bottom wall 9 while bottle 1 being at storage position (FIG. 3). The “z” in FIG. 5 represents the height of fluid content while bottle 1 being at the alignment position. The “z” is equal to the width of interior partition wall 10 between right side wall 7 and the free end of interior partition wall 10 while bottle 1 being at storage position (FIG. 3).

According to present invention, the entire fluid content will remain in reservoir 12 at all time while bottle 1 being rotated from the storage position to the alignment position, provided “h/H=z/W”. Wherein:
“h” representing the height of fluid content in reservoir 12 at storage position (FIG. 3);
“H” representing the height of reservoir 12 between the interior partition wall 10 and bottom wall 9 (FIG. 5);
“z” representing the width of interior partition wall 10 between the free end of partition wall 10 and right side wall 7 (FIG. 5);
“W” representing the width of bottle 1 between left side wall 6 and right side wall 7 (FIG. 5);
“d” representing the depth of bottle 1 between front wall 4 and back wall 5;
“W×d” representing the cross section area of reservoir 12 while bottle 1 being at the storage position;
“H×d” representing the cross section area of reservoir 12 while bottle 1 being at the alignment position;
“W×d×h=H×d×z” representing the equal fluid volume at the storage position and alignment position respectively.

The above height percentage (h/H) also represents the volume percentage (i.e., fluid volume/reservoir volume), or the storage volume efficiency of bottle 1. For example, the storage volume efficiency of bottle 1 can reach 100% if “h=H” and “z=W”.

In the event that the ratio of “h/H”0 is greater than “z/W”, the overfill will be transported from reservoir 12 to interior passage 11 through the second opening 14 while bottle 1 being rotated from the storage position to alignment position. However, the entire fluid content will still remain in bottle 1, provided the interior passage 11 at alignment position has a storage capacity to accommodate such an overfill.

When bottle 1 is rotated to the alignment position, the discharge spout 2 is at about the lowest level of bottle 1, which allows the discharge spout 2 to be easily aligned to the fill port of engine crankcase. There is no need for bottle 1 being rotated beyond the alignment position while accessing and aligning discharge spout 2 to the fill port. Consequently, bottle 1 prevents a premature oil discharge or spillage while accessing and aligning the discharge spout to the fill port.

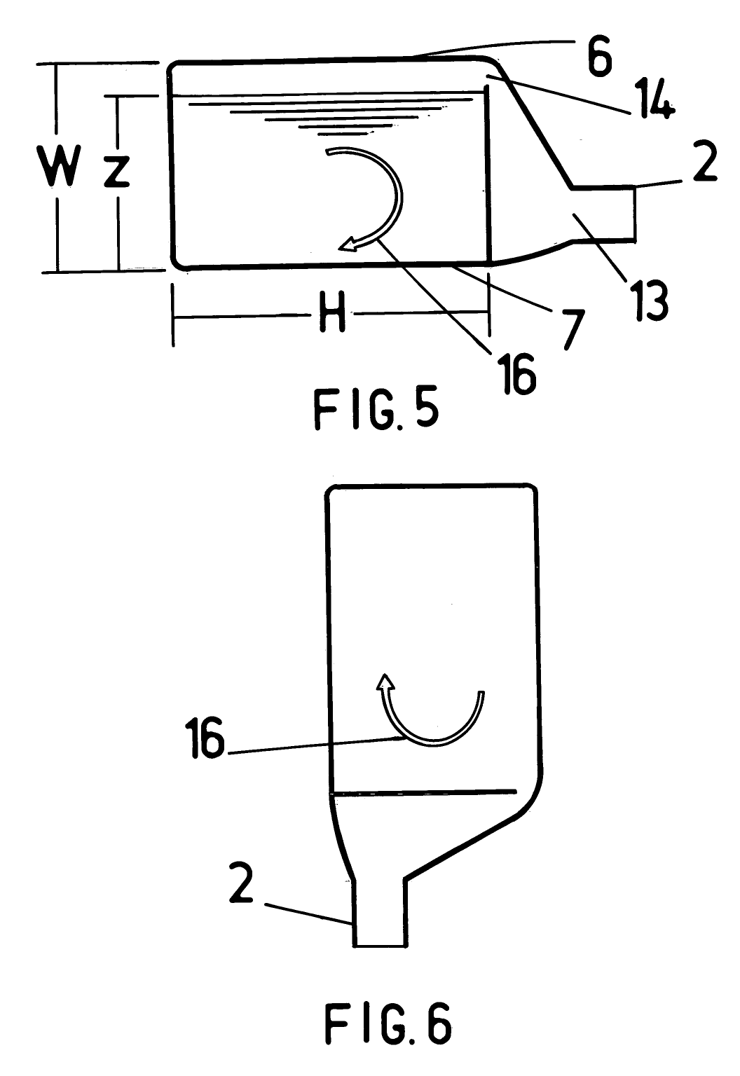

FIG. 6 shows bottle 1 being emptied at a final pouring position after being rotated 90 degree from the alignment position (FIG. 5). Bottle 1 is rotated from the alignment position to the final pouring position in the same direction 16 as bottle 1 being rotated from the storage position to alignment position. Since discharge spout 2 is in immediate proximity of fill port while bottle 1 being at alignment position, discharge spout 2 will remain in immediate proximity of fill port while bottle 1 being rotated from the alignment position to final pouring position. Consequently, it is unlikely that fluid is spilled outside of fill port when bottle 1 is at the final pouring position.

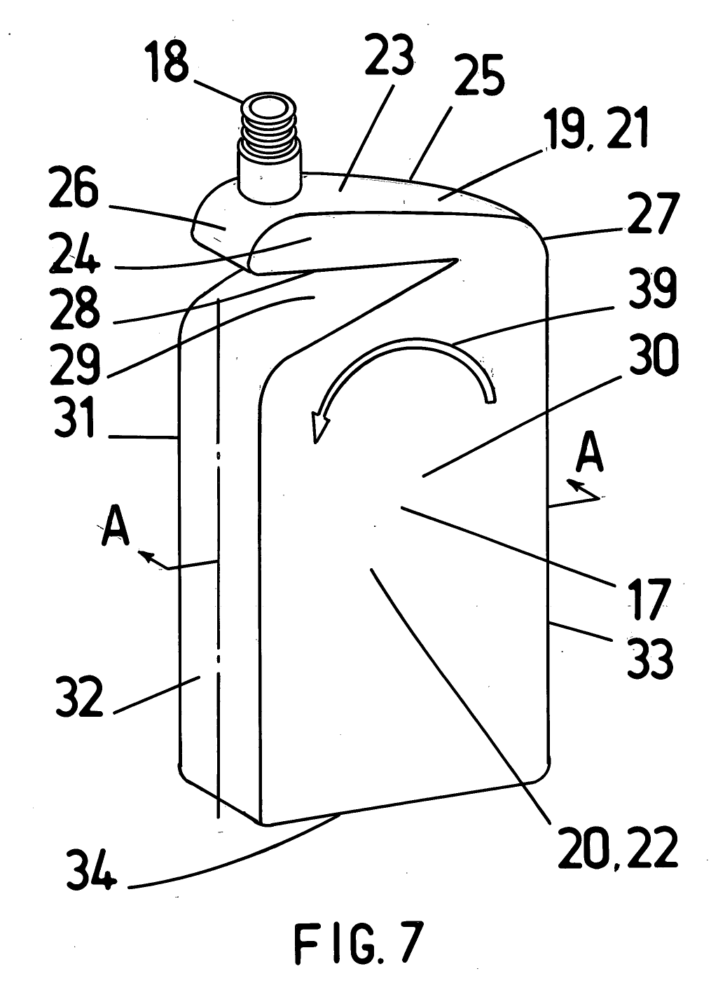

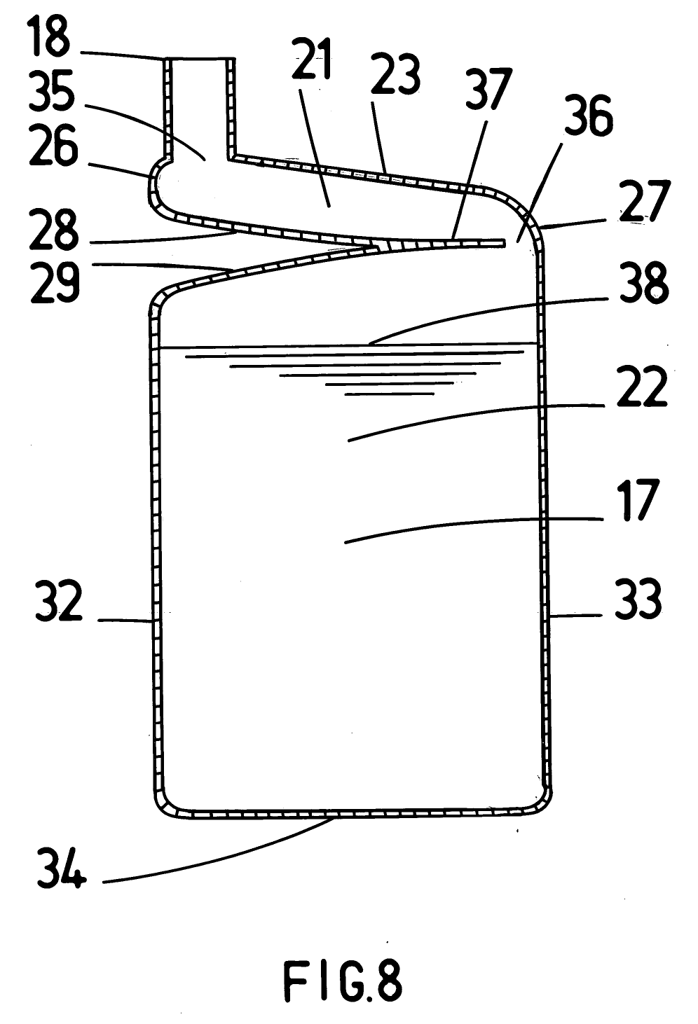

FIG. 7 is a perspective view of the second preferred embodiment of fluid bottle of present invention at storage position. FIG. 8 is a cross section view A-A of FIG. 7. In FIG. 7 and FIG. 8, the fluid bottle 17 comprises of a discharge spout 18, a first hollow body 19 and a second hollow body 20. The first hollow body 19 and second hollow body 20 form an interior passage 21 and reservoir 22 of bottle 17 respectively. The first hollow body 19 comprises of a first top wall 23, a first front wall 24, a first back wall 25, a first left side wall 26, a first right side wall 27 and a first bottom wall 28. The second hollow body 20 comprises of a second top wall 29, a second front wall 30, a second back wall 31, a second left side wall 32, a second right wall 33 and a second bottom wall 34. The second front wall 30 and back wall 31 are substantially parallel. The second left side wall 32 and right side wall 33 are substantially parallel. The discharge spout 18 is integrated to the first top wall 23 of first hollow body 19, where the first opening 35 of interior passage 21 is formed. The discharge spout 18 is offset from the first right side wall 27 toward the first left side wall 26. The second opening 36 of interior passage 21 is formed at the joint where the first hollow body 19 and second hollow body 20 are integrally connected. The first hollow body 19 and second hollow body 20 are integrally connected by connecting the first front wall 24 to second front wall 30, the first back wall 25 to second back wall 31, the first right side wall 27 to second right side wall 33, and the first bottom wall 28 to second top wall 29. A portion of the first bottom wall 28 is merged with a portion of second top wall 29 that forms an interior partition wall 37. The second opening 36 of interior passage 21 is located between the free end of interior partition wall 37 and second right side wall 33. Therefore, the second opening 36 is offset from the second left side wall 32 toward the second right side wall 33. The second top wall 29 slopes down from the second right side wall 33 to the second left side wall 32. The first top wall 23 and first bottom wall 28 slope down from the first left side wall 26 to the first right side wall 27. These slopes provide better pouring ability while bottle 17 being rotated upside down (180 degree) to a final pouring position. FIG. 8 shows reservoir 22 being filled to level 38 corresponding to the bottle's full storage capacity. Bottle 17 is rotated about 90 degree from the storage position to an alignment position in the direction 39 from the second right side wall 33 to the second left side wall 32. Bottle 17 is rotated about 90 degree from the alignment position to a final pouring position in the same direction 39.

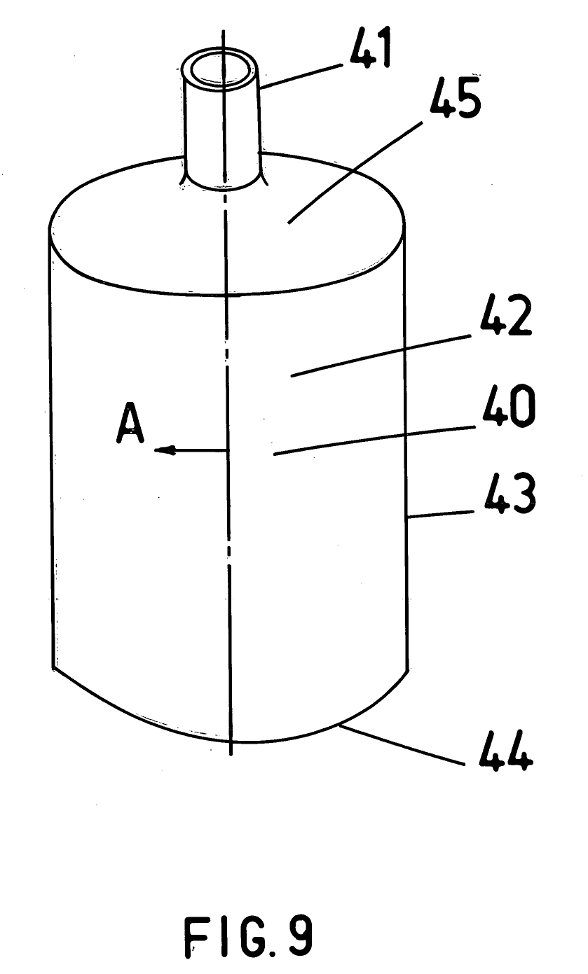

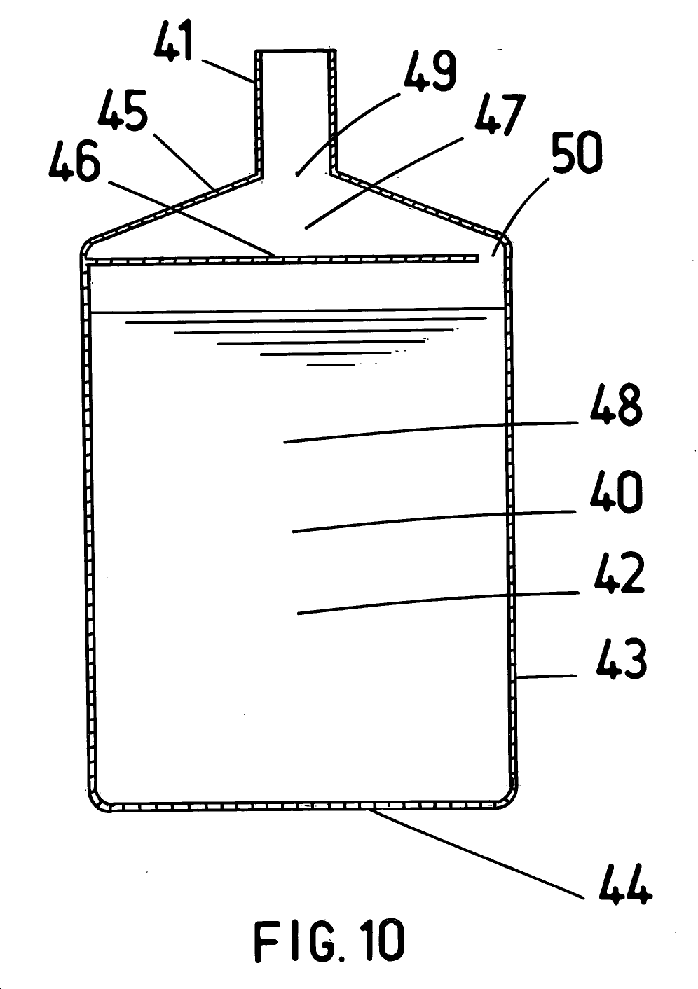

FIG. 9 is a perspective view of the third preferred embodiment of fluid bottle of present invention at storage position. FIG. 10 is a cross section view A-A of FIG. 9. In FIG. 9 and FIG. 10, the fluid bottle 40 comprises of a discharge spout 41, and a cylindrical hollow body 42. The discharge spout 41 is integrated to the top of hollow body 42 along the centerline of the hollow body 42. The cylindrical hollow body 42 has a round vertical wall 43, a bottom wall 44, and a top wall 45 converging the upper end of vertical wall 43 to the discharge spout 41. Within the hollow body 42, there is an interior partition wall 46 that divides the hollow body 42 into an interior passage section 47 and a reservoir section 48.

The first opening 49 of interior passage 47 is formed where the discharge spout 41 joints top wall 45. The second opening 50 of interior passage 47 is formed between the free end of interior partition wall 46 and vertical wall 43.

Bottle 40 is rotated about 90 degree from the storage position to an alignment position in the direction from the second opening 50 to the first opening 49. Bottle 40 is rotated another 90 degree from the alignment position to a final pouring position in the same direction. Bottle 40 can be used to replace the conventional water bottle of prior art that is mounted upside down on a water dispenser. Bottle 40 prevents or minimizes water spillage while mounting the bottle upside down on a water dispenser.

It is understood that the fluid bottle of present invention is not limited for use as a motor oil bottle. The fluid bottle of present invention may have a variety of dimension or shape other than those as described in specifications above. The fluid bottles as described in specifications are intended as illustrative of some of the possible embodiments of the invention. Other embodiments and modification besides the embodiments specially mentioned may be made in the techniques and structures described herein and depicted in the accompany drawings without departing substantially from the scope and concept of the present invention.

What is claimed:

1. A fluid bottle comprising of a hollow body, and a discharge spout integrated to the top of said hollow body for filling and emptying said bottle, wherein:
Said hollow body being divided into a top section and a bottom section, in which said top section forming an interior passage, said bottom section forming a reservoir, said interior passage providing a flow path for transporting a fluid content between said discharge spout and said reservoir, and said reservoir providing a storage area for storing said fluid content; and
Said interior passage having a first opening connecting said interior passage to said discharge spout through which said fluid content being transported between said interior passage and said discharge spout, and a second opening connecting said interior passage to said reservoir through which said fluid content being transported between said interior passage and said reservoir; and
Said bottle being at a storage position, in which said discharge spout being at a vertical position at the highest level of said bottle, said second opening of said interior passage having a vertical centerline that is offset from the centerline of said hollow body, and said reservoir being filled to a level below said second opening of said interior passage; and
Said bottle being at an alignment position, in which said discharge spout being positioned at about the lowest level of said bottle that enabling said discharge spout to be aligned with a fill port of a receiver in immediate proximity of said fill port; and
Said bottle being rotated from said storage position to said alignment position in a direction from said centerline of said second opening of said interior passage to said centerline of said hollow body; and
Said fluid content in its entirety being maintained within said bottle while said bottle being rotated from said storage position to said alignment position; and
Said bottle being at a final pouring position, in which said discharge spout being positioned at the lowest level of said bottle for emptying said bottle; and
Said bottle being rotated from said alignment position to said final pouring position in said direction that said bottle being rotated from said storage position to said alignment position; and
Said discharge spout being maintained in immediate proximity of said fill port of said receiver while said bottle being rotated from said alignment position to said final pouring position; and
Said fluid content being discharged directly to said fill port of said receiver without a spillage outside of said fill port while said bottle being emptied at said final pouring position.

2. The fluid bottle of claim 1, wherein said bottle is rotated about 90 degree from said storage position to said alignment position in the direction from said centerline of said second opening of said interior passage to said centerline of said hollow body, in which said second opening of said interior passage is rotated from a horizontal position to a vertical position at about the highest level of said bottle, and said fluid content in its entirety is maintained within said bottle.

3. The fluid bottle of claim 1, wherein said bottle is rotated about 90 degree from said alignment position to said final pouring position in the same direction as said bottle being rotated from said storage position to said alignment position, in which said discharge spout is maintained in immediate proximity of said fill port, and said fluid content is discharged directly to said fill port of said receiver without a spillage outside of said fill port.

4. The fluid bottle of claim 1, wherein said fluid content in its entirety is maintained within said reservoir below said second opening of said interior passage at all time while said bottle being rotated from said storage position to said alignment position.

5. The fluid bottle of claim 1, wherein said fluid content in its entirety is maintained within said reservoir and said interior passage below said second and first openings of said interior passage respectively at all time while said bottle being rotated from said storage position to said alignment position.

6. The fluid bottle of claim 1, wherein an interior partition wall is integrated within said hollow body that divides said hollow body into said interior passage and said reservoir, and said second opening of said interior passage being formed between the free end of said interior partition wall and said hollow body.

7. The fluid bottle of claim 1, wherein said interior passage, said reservoir, and said second opening of said interior passage being integrally formed by exterior walls only.

8. The fluid bottle of claim 1, wherein said interior passage, said reservoir, and said second opening of said interior passage being integrally formed by a combination of an interior partition wall and exterior walls.

9. The fluid bottle of claim 6, wherein said hollow body having a substantially rectangular body comprises of a front wall a back wall, a left side wall, a right side wall, a bottom wall and a top wall, in which said front wall and said back wall being substantially parallel, said left side wall and said right side wall being substantially parallel, said first opening of said interior passage being offset from said left side wall toward said right side wall, and said second opening of said interior passage being formed between the free end of said interior partition wall and said left side wall, having an offset from said right side wall toward said left side wall.

10. The fluid bottle of claim 6, wherein said hollow body having a substantially cylindrical body comprises of a round vertical wall, a bottom wall, and a top wall converging the upper end of said round vertical wall to said discharge spout, in which said first opening of said interior passage being centrally located along the centerline of said hollow body, and said second opening of said interior passage being formed between the free end of said interior partition wall and said round vertical wall.

11. The fluid bottle of claim 7, wherein said exterior walls of said interior passage comprises of a first top wall, a first front wall, a first back wall, a first left side wall, a first right side wall and a first bottom wall, and said exterior walls of said reservoir comprises of a second top wall, a second front wall, a second back wall, a second left side wall, a second right wall and a second bottom wall, in which said first and second front walls being integrally connected, said first and second back walls being integrally connected, said first and second right side walls being integrally connected, said first bottom wall and said second top wall being integrally connected, said first opening of said interior passage being formed with an offset from said first right side wall toward said first left side wall, and said second opening of said interior passage being formed with an offset from said first left side wall toward said first right side wall.

12. The fluid bottle of claim 8, wherein said exterior walls of said interior passage comprises of a first top wall, a first front wall, a first back wall, a first left side wall, a first right side wall and a first bottom wall, and said exterior walls of said reservoir comprises of a second top wall, a second front wall, a second back wall, a second left side wall, a second right wall and a second bottom wall, in which said first and second front walls being integrally connected, said first and second back walls being integrally connected, said first and second right side walls being integrally connected, said first bottom wall and said second top walls being integrally connected so that a portion of said first bottom wall and said second top wall being merged to form said interior partition wall, said first opening of said interior passage being formed with an offset from said first right side wall toward said first left side wall, and said second opening of said interior passage being formed with an offset from said first left side wall toward said first right side wall.

13. The fluid bottle of claim 9, wherein said interior partition wall and said bottom wall are substantially parallel.

14. The fluid bottle of claim 9, wherein said top wall slopes down from said right side wall to said left side wall.

15. The fluid bottle of claim 11, wherein said second top wall slopes down from said second right side wall to said second left side wall.

16. The fluid bottle of claim 11, wherein said first top and bottom walls slope down from said first left side wall to said first right side wall.

17. The fluid bottle of claim 12, wherein said second top wall slopes down from said second right side wall to said second left side wall.

18. The fluid bottle of claim 12, wherein said first top and bottom walls slope down from said first left side wall to said first right side wall.

19. The fluid bottle of claim 1, wherein said fluid bottle is made entirely from plastic molding.
